(19) United States
(12) Patent Application Publication
(10) Pub. No.: US 2010/0066834 A1
(43) Pub. Date: Mar. 18, 2010

(54) IMAGING APPARATUS

(76) Inventor: Gerald Bate, County Durham (GB)

Correspondence Address: JAMES C. WRAY, 1493 CHAIN BRIDGE ROAD, SUITE 300, MCLEAN, VA, 22101, US

(21) Appl. No.: 12/312,052

(22) PCT Filed: Oct. 23, 2007
(86) PCT No.: PCT/GB2007/004063

§ 371 Date: Jun. 17, 2009

(30) Foreign Application Priority Data
Oct. 23, 2006 (GB) 0621037.1

(51) Int. Cl. H04N 7/18; G06F 21/00; G06F 15/16

(52) U.S. Cl. 348/159; 726/5; 345/419; 709/206; 345/649; 348/E07.085

(57) ABSTRACT

An imaging apparatus for creating a rotatable three dimensional image of an object comprises a housing (3) and a plurality of cameras (6,8,10) attached to the housing and facing towards an object area wherein each camera is operated substantially simultaneously to create a series of images which can be then be combined to create the three dimensional image.

The present invention relates to an imaging apparatus and, in particular, to one imaging apparatus suitable for taking a three dimensional image of an object.

Many audio visual presentations show goods such as motor vehicles by rotating the goods around an axis to present the viewer with a three dimensional view of the goods. Typically, the produced image that taken of the object over half a hemisphere, namely 2π steradians. This type of presentation is often used in the sale of cars, motorbikes or other large items. The point of the illustration is to show the entire vehicle and to give the viewer a better sense of the whole vehicle.

Currently, in order to produce such an image, the vehicle must be mounted on a turntable and rotated whilst images of the car are taken. Providing a housing in which a large turntable suitable to take the weight of the car is located, is expensive and the process of taking a large number of photographs is time-consuming.

A car auction will typically have a website where the cars that are to be sold are advertised. In addition, auctions tend to sell a high volume of cars in any given day. Potential buyers will often view a website and when buying a car, it is important for the potential buyer to be able to see the car at many different angles. The existing technology for doing this requires a number of photographs to be taken in sequence and the process takes too long and is not cost effective when a large number of cars need to be photographed.

A similar issue exists for auction rooms that sell other types of goods such as furniture or collectables.

The internet has provided an extremely large marketplace for individuals to sell their own goods or the goods of their company. Goods of all shapes and sizes from jewelry to cars, or other vehicles for example are sold on-line. Where a person is selling goods on the internet, it is extremely likely that the vendor will have a photograph of the goods on the website in order to attract potential buyers. It is often the case that the vendor will take three or four photographs of the goods, perhaps taken from different angles, and display them on a website.

It is an object of the present invention to provide an improved imaging apparatus and method for producing a 3 dimensional image of an object.

### SUMMARY OF INVENTION

In accordance with a first aspect of the present invention there is provided an imaging apparatus for creating a rotatable three dimensional image of an object, the apparatus comprising:

a housing with an object area for locating an object in position within the housing; and

imaging means arranged around the housing,

the imaging means being configured to produce a three dimensional image of an object in the object area.

Preferably, the housing is adapted to accommodate a motor vehicle.

Preferably, the housing is provided with an entrance so as to allow the object access to the object area.

Preferably, the housing is provided with an exit so as to allow the object to be removed from the object area. Optionally the entrance and the exit coincide.

Preferably, the housing comprises enclosed sides.

Optionally, the housing comprises an open frame.

Preferably, the imaging means comprises a plurality of cameras attached to the housing and arranged to face the object area.

Preferably, the housing is dome-shaped.

Alternatively, the housing may be generally cubic in shape or any suitable shape that allows the imaging means to function properly and conveniently allows objects to be placed in the object area.

Preferably, each camera is adapted to form an image of the entire object area.

Optionally, each camera is adapted to form an image of part of the object area.

Preferably, the plurality of cameras are located at predetermined position with respect to each other.

Preferably, the plurality of cameras are arranged such that each image from a camera overlaps with an image from an adjacent camera.

Preferably each camera is operated substantially simultaneously.

Preferably, the imaging means further comprises software for combining images of the plurality of cameras.

Preferably, the apparatus further comprises a controller for controlling the operation of the imaging means.

Preferably, the controller comprises a user interface.

Preferably, the controller comprises a selector for selecting the output format of the image file.

Preferably, the image file is stored on and retrievable from a secure website.

Preferably, the apparatus provides an output the output comprising information on the address and password for the secure website.

Preferably, the output is in the form of a print-out.

Preferably, the user interface is adapted to allow a user to input an email address to which the image file is to be sent.

Preferably, the user interface is provided with means for writing the image file onto a storage medium. The storage medium may be a memory stick, CD, DVD or other suitable storage medium.

In accordance with a second aspect of the present invention there is provided a kiosk incorporating the apparatus of the first aspect of the invention.

According to a third aspect of the present invention there is provided a method of generating a three dimensional rotatable image of an object, the method comprising the steps of:
1) locating an object within an object area;
2) taking a plurality of images of various elevations of the object;
3) combining the plurality of images taken of the various elevations of the object.

Preferably the three dimensional image is rotatable through 4π steradians.

Preferably the step of combining the plurality of images comprises the production of an image file.

Optionally the image file is emailed to a predetermined e-mail address. Alternatively, the image file is stored on a storage device.

Optionally the storage device comprises a secure website. In this embodiment the method further comprises the step of providing a user with access information for the secure website.

### BRIEF DESCRIPTION OF DRAWINGS

The present invention will now be described by way of example only with reference to the accompanying drawings in which;

FIG. 1 illustrates the position of imaging means on a housing in accordance with the present invention;

FIG. 2 shows an apparatus in accordance with the present invention, adapted for taking 360° photographs of motor vehicles;

FIG. 3 illustrates the manner in which images are taken of a motor vehicle, in accordance with the present invention;

FIG. 4 is a second embodiment of the present invention in which the imaging means has fewer cameras than in the first embodiment;

FIGS. 5a to 5c show a third embodiment of the present invention in which the invention is contained within a kiosk and is adapted for imaging consumer goods;

FIG. 6 is a flow diagram showing the process by which a user can use the apparatus of the present invention; and

FIG. 7 is an alternative process to that shown in FIG. 6.

For consistency and clarity purposes the various features of the described imaging apparatus are referred to by the same reference numerals throughout the specification. Where appropriate, those reference numerals employed to describe the features common to alternative embodiments of the invention are also maintained within the specific description.

### DETAILED DESCRIPTION

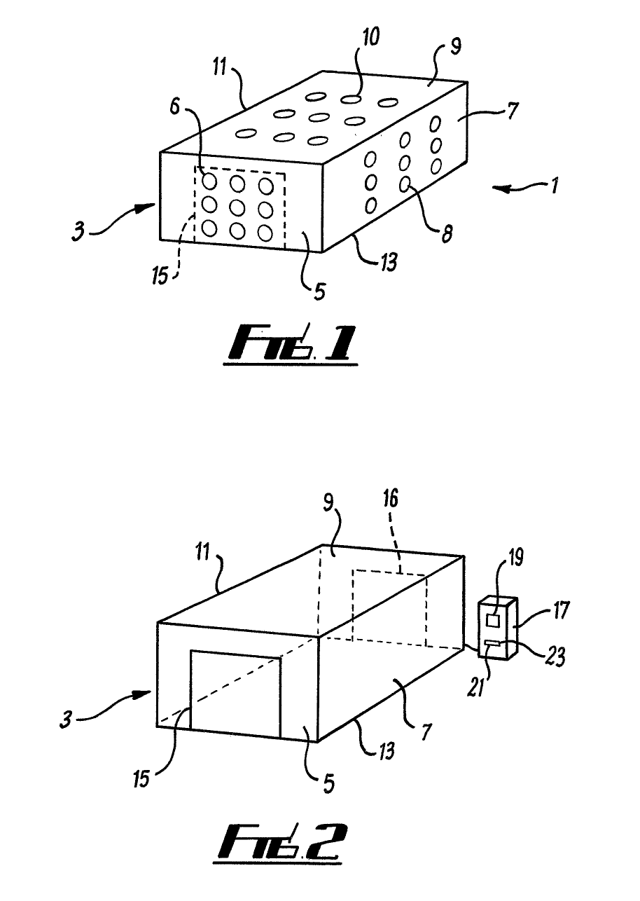

FIG. 1 shows a housing 3 which is substantially cubic in shape. Faces of the housing 5, 7, 9, 11 and 13 are represented in the diagram. These are all continuous surfaces and render the space inside the housing, which provides the object area, an enclosed space. Face 5 contains a doorway 15 which provides an entrance way into the housing for objects whose photograph is to be taken. The imaging means is provided by a plurality of cameras on each face, represented by reference numerals 6, 8 and 10. Each of the cameras is set at a fixed position with respect to one another and with respect to the object area. The cameras all point towards the object area and in this example of the present invention, each camera has a field of view large enough to capture the entire object area as viewed from its position on the housing.

FIG. 2 shows the exterior of an embodiment of the apparatus of the present invention as shown in FIG. 1.

As with FIG. 1, the apparatus comprises a housing 3 having faces 5, 7, 9, 11 and 13, entrance doorway 15 and exit doorway 16 are clearly shown on FIG. 2 as is the user control means 17.

The entrance door and exit door 15 and 16 are used to improve the efficiency of the apparatus by allowing a vehicle to move into the apparatus, have the photograph taken and move forward out of the apparatus. The control panel 17 comprises a screen 19, keyboard 21 and card reader 23. The screen 19 provides information on operational procedures to the user and allows the user to view the 3 dimensional image, once the photographs have been taken. The keyboard 21 allows a user to enter user specific information, such as an email address, personal details for example a pin number, or other relevant information. Card reader 23 allows the machine to accept credit or debit card payments for this service. It will be noted that the apparatus of the present invention may be used privately by, for example, a car auction house or may be situated in a public space such as a garage forecourt and may be usable by the general public. This second type of use is envisaged where a person may wish to conduct a private sale of a motorcar.

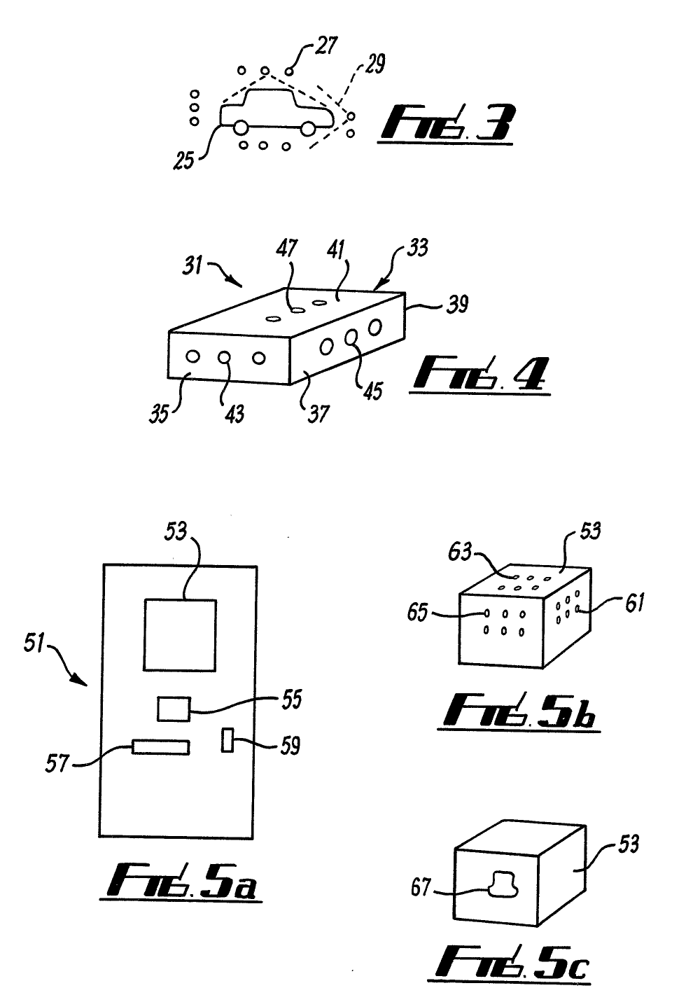

FIG. 3 provides the details of the object area for the present invention and shows the relationship between cameras 27, the motor vehicle 25 and the field of view of the cameras 29. As is shown in this figure, the field of view of the cameras encompasses the entire object area i.e a full three dimensional image can be captures showing the object over 4π steradians. In the presently described embodiment the each camera captures a full elevation of the car.

Use of the apparatus shown in FIGS. 1 to 3 will now be described. Where a person is operating a car auction, for example, the car auction may have a hundred or so cars that are for sale at any particular auction. In advance of the auction, details of each of the vehicles may be placed on a website. As discussed above, often simple static photographs of the car are taken to accompany details of the car on a website.

The current process for taking a three dimensional rotatable photographs of a vehicle is very time consuming as it involves taking multiple photographs of a vehicle in sequence either by physically moving around the vehicle or by rotating the vehicle on an expensive and difficult to maintain turntable. In practice the rotatable image produced is not an image over 4π steradians but one which is limited to half a hemisphere i.e. 2π steradians. Clearly the length of time that this takes also makes it expensive and impractical to do this for a car auction where a hundred or so cars are being auctioned in any one day.

The present invention provides an inexpensive solution to this problem as follows. As shown in FIG. 2 a person need only drive the car in through doorway 15, have the various image taken of the car by the imaging means which takes an image with each of the cameras at the same time. The car is then driven out of the object area and another car can then be driven into the apparatus where the similar process is undertaken and so on until all of the cars have been photographed.

In the case of each set of photographs of a car, software is used to mesh photographs together and to create the three dimensional images that is rotatable through 4π steradians. This image is contained in an image file which can then be sent to a predetermined location. This location may be a storage device, such as a memory stick CD rom, DVD or the like. Alternatively, or in addition it could be sent to a website or to an e-mail address. The present invention, therefore, greatly increases the speed and throughput when rotatable images of an object are to be made as well as increasing the area over which the image can be rotated.

FIG. 4 shows a second embodiment of the present invention with an imaging means containing fewer cameras shown in that of the embodiment of FIG. 1. In this embodiment 31 a housing 33 is shown having faces 35, 37, 39 and 41 imaging means comprising cameras 43, 45 and 47 is also shown.

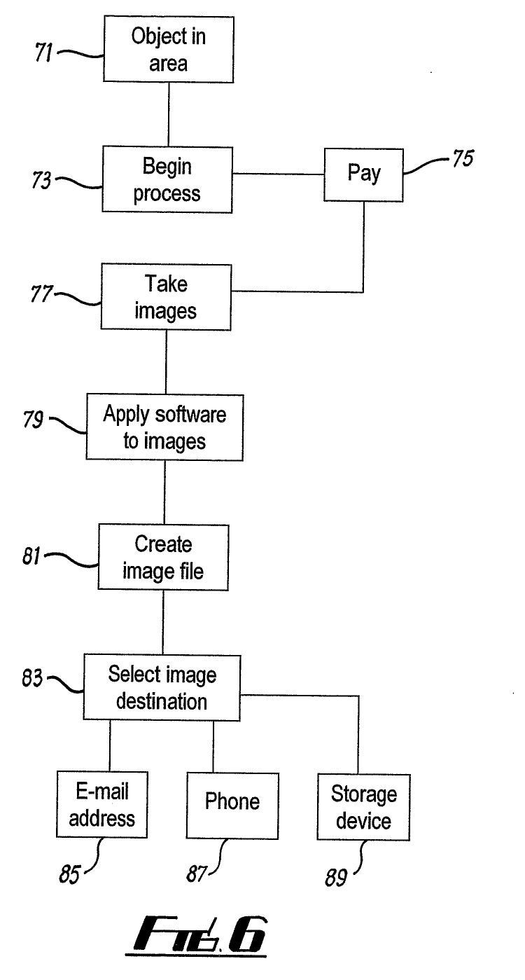

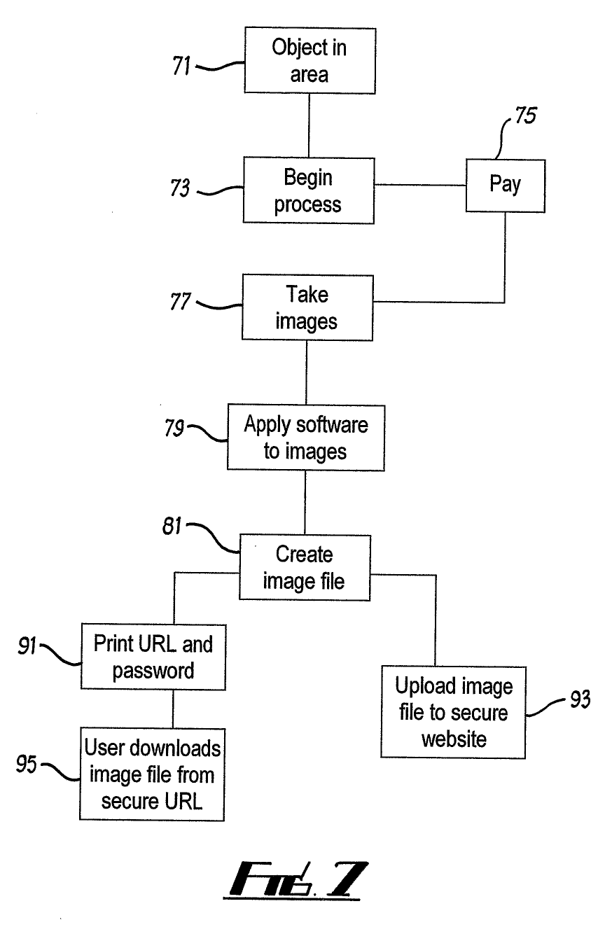

FIGS. 5a to 5c show a third embodiment of the present invention. In this embodiment of the present invention, the apparatus is configured as a kiosk, suitable for placement in a supermarket, shopping centre or the like and sized to take photographs of smaller consumer objects, for example electrical goods, items of clothing, or collectables. The apparatus comprises a kiosk 51 containing a housing 53 which houses an imaging means comprising a plurality of cameras. The housing is also shown in FIG. 5b along with imaging means 61, 63 and 65. The kiosk also comprises a screen 55, a keyboard 57 and a card reader 59. The screen 55 provides instructions for use and allows the user to view data he has input via the keyboard 57. The card reader 59 accepts debit or credit card payment.

The purpose of this embodiment of the present invention is to allow a consumer access to the technology that will provide a fully rotatable three dimensional images of an object. This application is of particular use because it will allow a person to take better images that will more fully illustrate the goods that they are intending to sell, for example over the internet. Any improvement in the visual representation of the goods which the person is selling will lead to an increased interest in their product and a better sale price. FIG. 5c shows an object 67, in the object area, contained within the housing 53.

FIG. 6 is a flow diagram showing one mode of operation of an embodiment of the invention. Firstly, an object is placed on the area 71 and the user begins the process by indicating they wish to proceed, this is done via a user interface. The user then pays for the service by credit or debit card for example 75 and the images are taken 77.

As discussed above, images of the entire elevation of the object may be taken by each of the cameras simultaneously. Once the images are taken, software processes the individual images in order to create the three dimensional rotatable image of the object. This image is created in an image file 81. Once the existence of the image file is made known to the user, the user is then asked to select a destination for the image file. The destination may be provided by the user as an e-mail address 85, a telephone number 78 or a storage device such as a memory stick which can be plugged into an appropriate interface on the kiosk.

FIG. 7 is a further mode of operation of an embodiment of the invention in which step 71 to 81 are identical to those of FIG. 6. However, in this mode of operation the image file is automatically uploaded to a secure website. The output of the kiosk is information concerning the website address and a password for accessing the image file upon the website 91. Once access has been achieved, the user can download their image file from the secure website 95. Alternatively, the kiosk may send details of the secure website by e-mail to an e-mail address prescribed by the user.

It will be appreciated that the shape of the housing 3 may not necessarily be cubic. In alternative embodiments the housing may be dome shaped or a pyramid shape. A further alternative is for the housing comprise a frame upon which the cameras can be located. What is required is that the cameras can be positioned so as to obtain images of the object over, at least 2π, but preferably 4π, steradians.

The foregoing description of the invention has been presented for the purpose of illustration and description, and is not intended to be exhaustive or to limit the invention to the precise form disclosed. The described embodiments were chosen and described in order to best explain the principals of the invention and its practical applications, to thereby enable others skilled in the art to best utilise the invention in various embodiments and with various modifications as are suited to the particular use upon completion. Therefore, further modifications and improvements may be incorporated without departing from the scope of the invention as defined by the appended claims.

1-34. (canceled)

35. An imaging apparatus for creating a rotatable three dimensional image of an object, the apparatus comprising:
a housing with an object area for locating an object in position within the housing; and
imaging means arranged around the housing;
the imaging means being configured to produce a three dimensional image of an object in the object area.

36. An imaging apparatus as claimed in claim 35, wherein the housing is adapted to accommodate a motor vehicle.

37. An imaging apparatus as claimed in claim 35, wherein the housing is provided with an entrance so as to allow the object access to the object area.

38. An imaging apparatus as claimed in claim 35, wherein the housing is provided with an exit so as to allow the object to be removed from the object area.

39. An imaging apparatus as claimed in claim 38, wherein the exit coincides with the entrance.

40. An imaging apparatus as claimed in claim 35, wherein the housing comprises enclosed sides.

41. An imaging apparatus as claimed in claim 35, wherein the housing comprises an open frame.

42. An imaging apparatus as claimed in claim 35, wherein the imaging means comprises a plurality of cameras attached to the housing and arranged to face the object area.

43. An imaging apparatus as claimed in claim 35, wherein the housing is dome-shaped.

44. An imaging apparatus as claimed in claim 35, wherein the housing may be generally cubic in shape or any suitable shape that allows the imaging means to function properly and conveniently allows objects to be placed in the object area.

45. An imaging apparatus as claimed in claim 42, wherein each camera is adapted to form an image of the entire object area.

46. An imaging apparatus as claimed in claim 42, wherein each camera is adapted to form an image of part of the object area.

47. An imaging apparatus as claimed in claim 42, wherein the plurality of cameras are located at predetermined position with respect to each other.

48. An imaging apparatus as claimed in claim 42, wherein the plurality of cameras are arranged such that each image from a camera overlaps with an image from an adjacent camera.

49. An imaging apparatus as claimed in claim 42, wherein each camera is operated substantially simultaneously.

50. An imaging apparatus as claimed in claim 35, wherein the imaging means further comprises software for combining images of the plurality of cameras.

51. An imaging apparatus as claimed in claim 50, wherein the images are combined to form an image file.

52. An imaging apparatus as claimed in claim 35, wherein the apparatus further comprises a controller for controlling the operation of the imaging means.

53. An imaging apparatus as claimed in claim 51, wherein the controller comprises a user interface.

54. An imaging apparatus as claimed in claim 52, wherein the controller comprises a selector for selecting the output format of the image file.

55. An imaging apparatus as claimed in claim 51, wherein the image file is stored on, and retrievable from, a secure website.

56. An imaging apparatus as claimed in claim 55, wherein the apparatus provides an output, the output comprising information on the address and password for the secure website.

57. An imaging apparatus as claimed in claim 56, wherein the output is in the form of a print-out.

58. An imaging apparatus as claimed in claim 53, wherein the user interface is adapted to allow a user to input an e-mail address to which the image file is to be sent.

59. An imaging apparatus as claimed in claim 53, wherein the user interface is provided with means for writing the image file onto a storage medium.

60. A kiosk incorporating the apparatus of the imaging apparatus as claimed in claim 35.

61. A method of generating a three dimensional rotatable image of an object, the method comprising the steps of:
locating an object within an object area;
taking a plurality of images of various elevations of the object;
combining the plurality of images taken of the various elevations of the object.

62. A method as claimed in claim 61, wherein the three dimensional image is rotatable through 4π steradians.

63. A method as claimed in claim 61, wherein the step of combining the plurality of images comprises the production of an image file.

64. A method as claimed in claim 63, wherein the image file is e-mailed to a predetermined e-mail address.

65. A method as claimed in claim 63, wherein the image file is stored on a storage device.

66. A method as claimed in claim 65, wherein the storage device comprises a secure website.

67. A method as claimed in claim 66, wherein the method further comprises the step of providing a user with access information for the secure website.
